(19) United States
(12) Patent Application Publication
(10) Pub. No.: US 2006/0120481 A1
(43) Pub. Date: Jun. 8, 2006

(54) Apparatus and method for data transmission by constellation combination in a communication system

(75) Inventors: Sung-Kwon Hong, Seoul (KR); Seung-Hoon Park, Seoul (KR); Dong-Seek Park, Yongin-si (KR); Young-Kwon Cho, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/295,065

(22) Filed: Dec. 6, 2005

(30) Foreign Application Priority Data
Dec. 6, 2004 (KR) 2004-102041

(51) Int. Cl. H04L 27/36

(52) U.S. Cl. 375/298

(57) ABSTRACT

Disclosed are an apparatus and a method for efficiently transmitting data by constellation combination in a communication system. The method includes encoding and interleaving transmission data according to a predetermined encoding scheme, and dividing an interleaved signal into at least one signal interval corresponding to at least one modulation scheme; and transmitting data obtained by modulating at least one divided signal interval according to a modulation scheme corresponding to the divided signal interval, the data satisfying a predetermined data rate setup in a system by applying a preset modulation scheme to each divided signal interval.

This application claims priority under 32 U.S.C. § 119 to an application entitled “Apparatus And Method For Data Transmission By Constellation Combination In A Communication System” filed in the Korean Industrial Property Office on Dec. 6, 2004 and assigned Serial No. 2004-102041, the contents of which are incorporated herein by reference.

### BACKGROUND OF THE INVENTION

1. Field of the Invention

The present invention relates to a communication system, and more particularly to an apparatus and a method for data transmission.

2. Description of the Related Art

In general, the biggest problem in signal transmission in a wireless communication system is the addition to the transmitted signal of noise on a communication path. That is, when a transmitter transmits data, the data passes through a communication path (especially, a wireless path) before reaching a receiver. Noise is unavoidably added to the signal while the signal passes through the wireless path, so that the receiver receives the signal including the added noise. Therefore, it is necessary for the receiver to remove the added noise from the signal, in order to demodulate an exact signal and restore the original data.

According to a definition for a code rate, the code rate has a value of k/n when n number of codewords are output for k number of inputs. The code rate may change according to the characteristics of the transmission channel. Further, in order to enhance the error correction capability of the receiver, the transmitter must perform the coding with a small code rate. However, when coding is performed with a small code rate, the data rate is also reduced. Therefore, in a communication system, the data rate and the code rate must be properly controlled by a trade-off relation.

FIG. 1 is a block diagram of a transmitter for data transmission in a conventional communication system.

The conventional communication system shown in FIG. 1 includes an encoder 102, a puncturing processor 104, an interleaver 106, and a mapper 108.

Referring to FIG. 1, when there is data (i.e., information bits) to be transmitted, the encoder 102 receives the data, generates coded symbols by encoding the data according to an encoding scheme, and outputs the coded symbols to the puncturing processor 104. The puncturing processor 104 receives the coded symbols from the encoder 102 and punctures a preset number of bits of the coded symbols in accordance with a code rate.

For example, assuming that the encoder 102 uses a code rate of ½ and the final code rate which the transmitter targets is ⅔, the following process is performed. When 200 information bits are input to the encoder 102 having a code rate of ½, the encoder 102 generates a 400 bit codeword by encoding the input information bits according to an encoding scheme, and outputs the generated 400 bit codeword to the puncturing processor 104. After receiving the 400 bit codeword, the puncturing processor 104 punctures 100 bits of the received 400 bit codeword, in order to satisfy the code rate of ⅔. The puncturing will be described in more detail later with reference to FIG. 2.

The signal output from the puncturing processor 104 is input to the interleaver 106. The interleaver 106 interleaves the punctured signal from the puncturing processor 104 and outputs the interleaved signal to the mapper 108. The mapper 108 generates a modulation symbol by modulating the interleaved signal from the interleaver 106 and outputs the modulation symbol. The modulation schemes include a Binary Phase Shift Keying (BPSK) scheme, a Quadrature Phase Shift Keying (QPSK) scheme, a 16 Quadrature Amplitude Modulation (16 QAM) scheme, and a 64 QAM scheme.

FIG. 2 illustrates a process for coding and modulation according to puncturing in a conventional communication system.

FIG. 2 is based on an assumption that the 200 information bits are input, an encoder having a code rate of ½ is used, the encoder uses convolutional codes, and the final code rate which the transmitter targets is ⅔.

Referring to FIG. 2, the 200 information bits are expanded to 400 bits while they pass through an encoder having a code rate of ½, using convolutional codes. Some of the bits of the coded symbol, having passed through the encoder, are punctured, in order to satisfy the code rate of ⅔. For example, when convolutional codes with a code rate of ½ are input at a period of two bits, the encoder outputs bits at a period of four bits. If the fourth bit of the four bit period is punctured, the remaining three bits are the output bits. Also, two bits are mapped into one symbol according to a modulation scheme, for example, a QPSK scheme. As a result, convolutional codes satisfy the final target code rate of ⅔.

Hereinafter, a communication system including a Base Station (BS) using rate ⅔ convolutional codes, a Mobile Station (MS), and another BS (for example, a neighbor BS) will be discussed. It is assumed that the neighbor BS also uses rate ⅔ convolutional codes.

First, the MS can receive signals from both the BS (a serving BS), in which the MS is located, and the neighbor BS. The MS can obtain diversity gain by combining these signals. In this case, if the fourth bit of each ⅔ rate convolutional code is punctured in both the serving BS and the neighbor BS, then the combined entire code also has a coder rate of ⅔. That is, it is possible to obtain a diversity gain through a chase combining method.

In general, the minimum hamming distance of a ⅔ convolutional code is 6 when the state number is 64. Specifically, the convolutional encoder includes several bit-unit memories and connecting lines for connecting and adding the stored values in the memories and the input values to the memories. The input bit stream is stored in the memories and is then sequentially transited according to passage of time. The bit streams output are subjected to an XOR operation between the input bit and the memory bit. The input bits and the memory bits are combined according to a combining scheme instead of being always connected to each other. When selecting the combined connection, a maximum performance of the convolutional codes is sought after. The connection between the memory bit and the input bit can be expressed by using a polynomial which is referred to as a generation polynomial. The optimum generation polynomials according to the state numbers have been already obtained for various code rates, which will not be described here because it is beyond the scope of the present invention.

In the convolutional encoder as described above, the state refers to the state of the memory. For example, when the memory is a two bit memory, the number of all of the cases which can be expressed by the memory is 4 (2²=4). Therefore, the memory has a state number of 4. That is, as the size of the memory increases, the state number of the memory exponentially increases along an exponent of 2.

The state number is a scale which represents the complexity of the encoding and decoding process and the maximum coding strength of a specific encoding scheme. The hamming distance refers to the number of different bits between different binary codewords. The smallest hamming distance from among the hamming distances of all of the codewords is the minimum hamming distance. The greater the state number, the greater the minimum hamming distance.

An error event probability of predetermined input information bits interleaved and convolution-encoded according to a band-effective modulation scheme can be defined by Equation (1) below.

$$P ( E ) ∝ {( \frac{1}{PD ( c , e )} )}^{L} \qquad ( 1 )$$

In Equation (1), P(E) refers to the error event probability, L refers to the hamming distance of the codewords, and PD(c, e) refers to the product of Euclidean distances of symbols of c and e. As noted from Equation (1), L is an important index of the error event probability. That is, as L increases, the error event probability exponentially decreases in proportion to the increase of L. Further, PD(c, e) is another index of the error event probability. That is to say, the greater the PD(c, e), the smaller the error event probability.

### SUMMARY OF THE INVENTION

As described above, if the transmitter transmits data after simultaneously performing the puncturing and modulation for the data, the code rate increases due to the puncturing. However, in contrast to the increase of the code rate, the hamming distance decreases. In the method described above, L, which is an important performance index in the fading channel, is too small. As a result, the method described above has an error event probability or error occurrence probability, which is too high.

Accordingly, the present invention has been made to solve at least the above-mentioned problems occurring in the prior art, and an object of the present invention is to provide an apparatus and a method for efficiently transmitting data by constellation combination in a communication system.

It is another object of the present invention to provide an apparatus and a method which can prevent the occurrence of time multiplexing loss by changing a code rate through constellation combination in a communication system.

It is another object of the present invention to provide an apparatus and a method for efficiently transmitting data through code rate control.

It is another object of the present invention to provide an apparatus and a method which can adaptively change a code rate without performing puncturing in signal transmission.

It is another object of the present invention to provide an apparatus and a method which can control a code rate by using a combination of various modulation schemes without performing puncturing.

It is another object of the present invention to provide an apparatus and a method for efficiently transmitting data through control of a code rate by a mapper.

It is another object of the present invention to provide an apparatus and a method which can efficiently change the data rate in a communication system.

In order to accomplish these objects, there is provided a method for data transmission in a communication system, the method includes encoding and interleaving transmission data according to a predetermined encoding scheme, and dividing an interleaved signal into at least one signal interval corresponding to at least one modulation scheme; and transmitting data obtained by modulating at least one divided signal interval according to a modulation scheme corresponding to the divided signal interval, the data satisfying a predetermined data rate setup in a system by applying a preset modulation scheme to each divided signal interval.

In accordance with another aspect of the present invention, there is provided an apparatus for data transmission in a communication system, the apparatus includes a mapping controller for encoding and interleaving a transmission data according to a predetermined encoding scheme, and dividing an interleaved signal into at least one signal interval corresponding to at least one modulation scheme; and a mapper for transmitting data obtained by modulating at least one divided signal interval according to a modulation scheme corresponding to the divided signal interval, the data satisfying a predetermined data rate setup in a system by applying a preset modulation scheme to each divided signal interval.

In accordance with another aspect of the present invention, there is provided a method for data modulation and mapping in a communication system, the method includes encoding and interleaving predetermined input data; dividing an interleaved signal into signal intervals corresponding to a plurality of modulation schemes; and mapping the signal intervals according to corresponding modulation schemes.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram of a transmitter for data transmission in a conventional communication system;

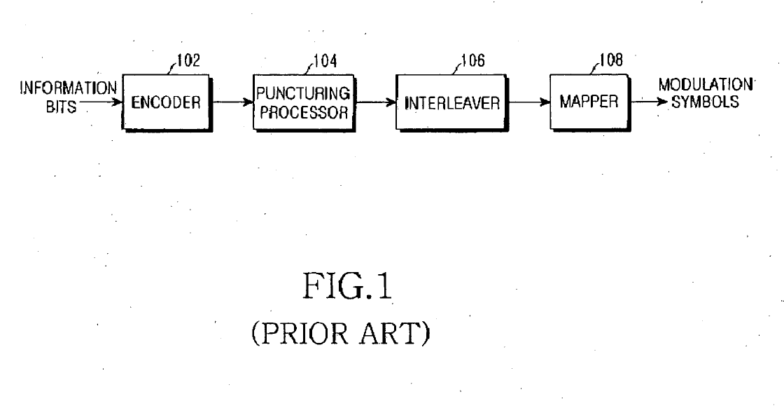

FIG. 2 illustrates a process for coding and modulation according to puncturing in a conventional communication system;

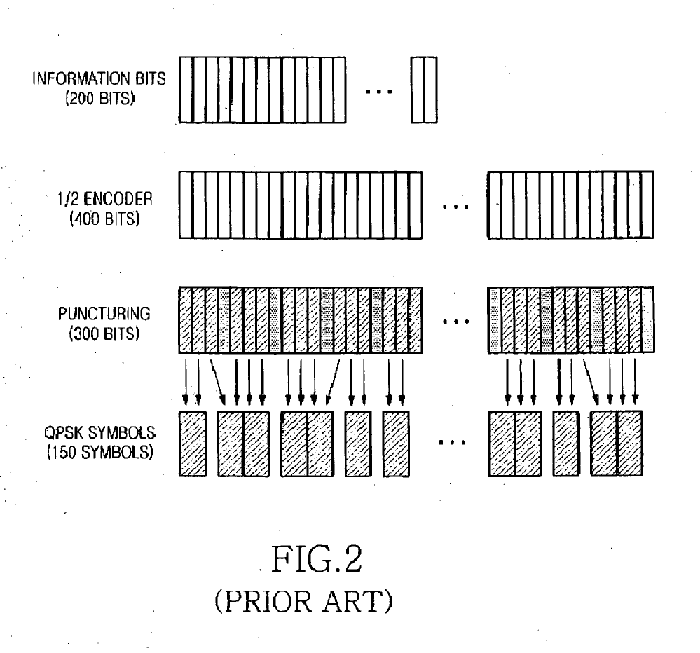

FIG. 3 is a block diagram of a transmitter for data transmission according to an embodiment of the present invention;

FIG. 4 illustrates a process for coding and modulation by constellation combination according to a preferred embodiment of the present invention;

FIG. 5 is a flowchart of a process for processing an input signal in a communication system according to a preferred embodiment of the present invention;

FIG. 6 is a flowchart of a process for data transmission in a communication system according to a preferred embodiment of the present invention; and

FIG. 7 is a graph for illustrating data rate performance according to a preferred embodiment of the present invention.

### DETAILED DESCRIPTION OF THE PREFERRED EMBODIMENT

Hereinafter, preferred embodiments of the present invention will be described with reference to the accompanying drawings. In the following description, a detailed description of known functions and configurations incorporated herein will be omitted when it may make the subject matter of the present invention unclear.

The present invention proposes an apparatus and a method which can improve the data rate through constellation combination and the order of the modulation of the constellation in a communication system. That is, the present invention does not use the puncturing in order to change the code rate. Instead, the present invention changes the code rate by constellation combination, thereby preventing time multiplexing loss.

The present invention proposes a method for effectively transmitting data through constellation combination in a communication system. That is, the present invention proposes an apparatus and a method for improving the data rate by reducing the bit error rate through a combination of different modulation orders instead of performing the conventional puncturing.

In a communication system, information processing is usually done for each block. That is, a transmitter groups information bits of a predetermined size into one unit block, and encodes, interleaves, modulates and then transmits the generated block. Then, a receiver receives the signal (block) from the transmitter, and performs processing of the block, such as demodulation, deinterleaving, and decoding. The block which is the basic unit of signal transmission/reception will be referred to as a “frame.”

Definitions of several terms will be discussed. First, “bit” refers to a basic unit for expressing information by using binary numbers. The term “symbol” refers to a basic unit of a baseband signal before it is modulated by a sub-carrier. One symbol corresponds to at least one bit. The term “frame” or “block” refers to a unit for information processing, which includes a plurality of bit combinations. That is, the frame or block is a unit greater than the symbol, which includes an integer number of symbols. Therefore, the frame or block has an integer number of bits.

If the information frame has a length of Nᵢ and the code rate is R₀, a length N_{c} of a coded frame or code frame can be defined by Equation (2).

$${N}_{c} = \frac{{N}_{i}}{{R}_{0}} \qquad ( 2 )$$

In Equation (2), in order to change the code rate R₀ to a code rate R_{d}, greater or less than the code rate R₀, it is necessary to eliminate a predetermined length increment or decrement from the length N_{c} of the code frame. For example, in order to change the code rate R₀ to the code rate R_{d} when the code rate R_{d} is greater than the code rate R₀(R_{d}>R₀), it is necessary to eliminate bits corresponding to δN_{c} from the length N_{c} of the code frame. In δN_{c}, δ is a mathematical symbol which indicates variance (increment or decrement).

$$δ {N}_{c} = ( \frac{{N}_{i}}{{R}_{d}} - \frac{{N}_{i}}{{R}_{0}} ) = {N}_{i} \cdot \frac{{R}_{d} - {R}_{0}}{{R}_{d} {R}_{0}} \qquad ( 3 )$$

If a 2^{q}-ary modulation scheme is used, the original code frame before the modulation has a symbol length

$${M}_{c} ( {M}_{c} = \frac{{N}_{c}}{q} ) .$$

In Equation (3), Nᵢ refers to the number of input information bits (i.e. the frame length of an input information frame), and M_{c} refers to the symbol length of the frame. In the 2^{q}-ary modulation, the number δM_{c} of channel code symbols which should be eliminated in order to obtain the code rate R_{d} is

$$\frac{δ {N}_{c}}{q} ( δ {M}_{c} = \frac{δ {N}_{c}}{q} ) .$$

In the present invention, it is possible to obtain the code rate R₀ by modulating as many symbols as

$$δ x = \frac{δ {N}_{c}}{δ q}$$

according to a 2^{q+δq}-ary modulation scheme. This result can be obtained by Equation (4).

$$δ x ( q + δ q ) + ( \frac{{N}_{i}}{{R}_{0} q} - δ x ) q = \frac{{N}_{i}}{{R}_{d}} \qquad ( 4 )$$

For example, it is assumed that ½ convolutional codes are used as channel codes, 200 bit information frames are encoded by a code rate of ½ into 400 bit code frames, and a code rate of ⅔ is the final target to be implemented. Specifically, if

$${R}_{0} = \frac{1}{2} , {R}_{d} = \frac{2}{3} ,$$

Nᵢ=200, and N_{c}=400 in Equation (3), the length δN_{c} of the first changed code frame is 100 as shown by Equation (5).

$$δ {N}_{c} = ( \frac{{N}_{i}}{{R}_{d}} - \frac{{N}_{i}}{{R}_{0}} ) = {N}_{i} \cdot \frac{{R}_{d} - {R}_{0}}{{R}_{d} {R}_{0}} = 200 \cdot \frac{\frac{2}{3} - \frac{1}{2}}{\frac{2}{3} \cdot \frac{1}{2}} = 100 \qquad ( 5 )$$

In Equation (5), when the Quadrature Phase Shift Keying (QPSK) modulation scheme is used, the symbol length M_{c} of the code frame is 200 (M_{c}=200). Also, in order to satisfy the code rate of ⅔ through the Quadrature Amplitude Modulation (QAM) modulation scheme, δq is 2 and

$$δ x = \frac{δ {N}_{c}}{δ q} = \frac{100}{2} = 50.$$

In conclusion, it is possible to obtain 150 modulation symbols satisfying the code rate of ⅔, by changing 50 QPSK modulation symbols out of 200 QPSK modulation symbols into QAM modulation symbols.

As described above, when as many symbols as δx are modulated into symbols of another modulation scheme, it can be said that the same code rate as that of the punctured code is obtained in the view of symbols. However, in the view of bits, it is possible to maintain the code rate of a mother code in the changed code, by using the different modulation scheme according to the present invention. Therefore, it is possible to obtain the time diversity gain which is obtained in a fading channel.

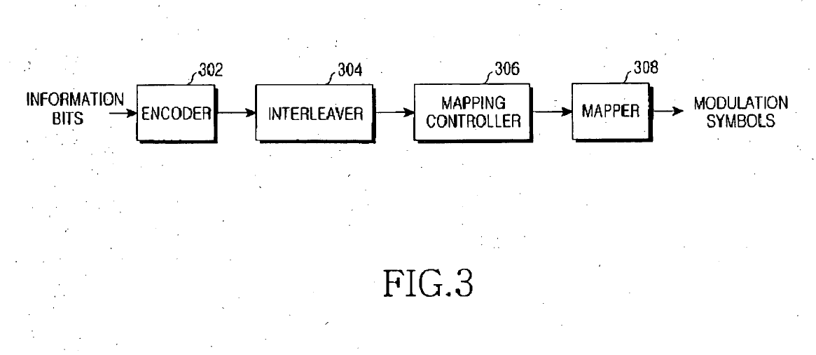

The above-mentioned process of the present invention can be easily understood from FIGS. 3 through 5.

FIG. 3 is a block diagram of a transmitter for data transmission according to an embodiment of the present invention.

The transmitter according to an embodiment of the present invention includes an encoder 302, an interleaver 304, a mapping controller 306, and a mapper 308.

Referring to FIG. 3, when there is data (i.e., information bits) to be transmitted, the encoder 302 receives the information bits, generates coded symbols by encoding the information bits according to a predetermined encoding scheme, and outputs the coded symbols to the interleaver 304. The interleaver 304 interleaves the coded symbols from the encoder 302 according to a predetermined interleaving scheme and outputs the interleaved symbols to the mapping controller 306. In order to identify bit stream positions of the symbols from the interleaver 304, the mapping controller 306 determines a mapping order in accordance with a predetermined data rate and outputs the determined mapping order and the symbols to the mapper 308. That is, the mapping controller 306 rearranges the coded symbols according to the mapping order, and the mapper 308 maps the symbols according to mapping order by using a corresponding mapping scheme. Specifically, the mapping controller 306 divides the interleaved signal into signal intervals for the modulation of the signal according to preset modulation schemes, and outputs to the mapper 308 modulation orders according to the modulation schemes.

When the mapping controller 306 divides the interleaved signal into signal intervals, the divided signal intervals may have uniform bits or non-uniform bits. The mapping controller 306 determines whether to apply a corresponding modulation scheme to each frame or each symbol of the divided signal intervals. Preferably, the modulation schemes are identified by the modulation order.

The mapper 308 outputs modulation symbols satisfying a target code rate setup in the system by changing the modulation order with reference to the modulation order information from the mapping controller 306. The modulation schemes include a Binary Phase Shift Keying (BPSK) scheme, a Quadrature Phase Shift Keying (QPSK) scheme, a 16 Quadrature Amplitude Modulation (16 QAM) scheme, and a 64 QAM scheme.

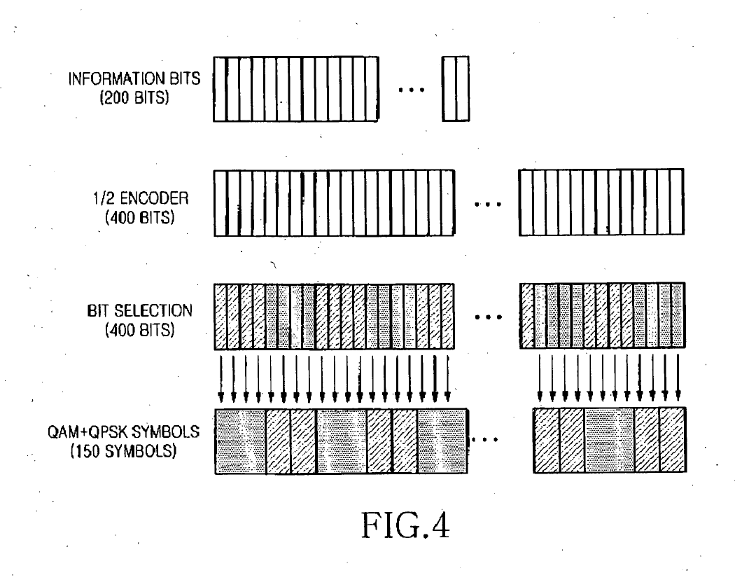

FIG. 4 illustrates a process for coding and modulation by constellation combination according to a preferred embodiment of the present invention.

Referring to FIG. 4, the information bits (e.g. 200 information bits) generated by the transmitter are enlarged to 400 bits while they pass through a ½ encoder using convolutional codes. Then, in order to satisfy the code rate (for example, ⅔) determined in the system, the 200 information bits are modulated by the QPSK scheme, and 50 information bits out of the 200 QPSK bits are then modulated by the QAM modulation scheme, thereby generating a modulation symbol of 150 bits satisfying the code rate of ⅔.

A number of information bits equal to δx (50 bits) to be modulated by a different modulation scheme (the QAM modulation scheme) can be extracted from the original bits in various ways, examples of which will be briefly described below.

First, the information bits to be modulated may be extracted at a regular interval from the original frame. Second, if there is an interleaver between the modulator and the channel encoder and the interleaver can perform uniform interleaving, a predetermined part of the output of the interleaver can be selected by the block. Otherwise, a part relatively less sensitive to the error can be selected, by taking into consideration the partially non-uniform error correction capability of the channel code.

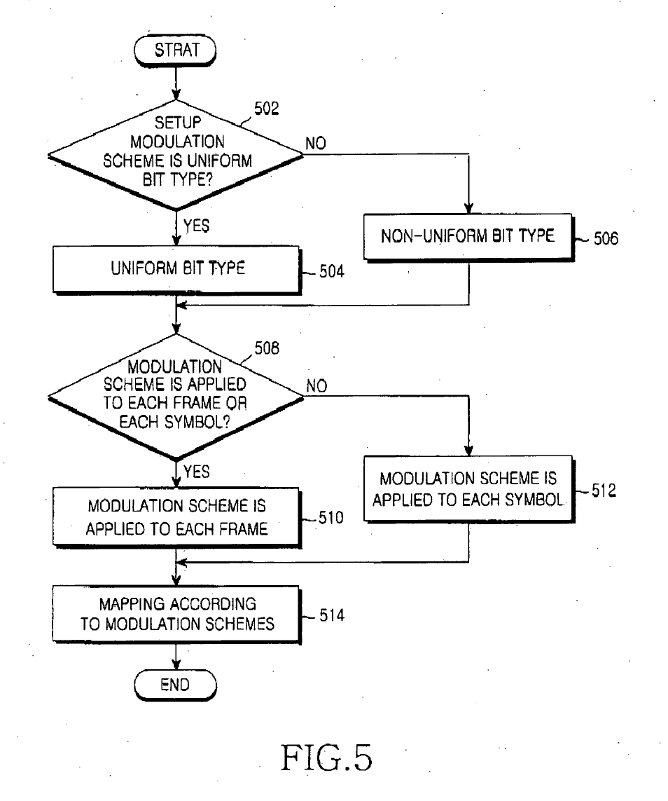

FIG. 5 is a flowchart of a process for processing an input signal in a communication system according to a preferred embodiment of the present invention.

A signal processing method according to a preferred embodiment of the present invention includes encoding and interleaving a predetermined input data; dividing the interleaved signal into multiple signals corresponding to at least one modulation schemes; and sequentially mapping and outputting the divided signals according to corresponding modulation schemes. Hereinafter, processes of mapping and signal transmission will be described in more detail with reference to FIG. 5.

Referring to FIG. 5, First, when there is a predetermined input data, the input data is encoded by a preset coding scheme and the encoded signals are then interleaved. Thereafter, the interleaved signals are divided into signal intervals for modulation of the signal intervals according to preset at least one modulation schemes. Specifically, in step 502, a modulation scheme setup in a system in order to modulate data is determined. When it is determined that the setup modulation scheme is a uniform bit type modulation, the process proceeds to step 504. In contrast, when the setup modulation scheme is a non-uniform bit type modulation, the process proceeds to step 506.

In step 504, modulation schemes are determined for the interleaved signals at a uniform bit interval. In step 506, modulation schemes are determined for the interleaved signals at random (non-uniform) bit intervals. In determining the modulation schemes for the signals at non-uniform bit intervals, parts that are relatively less sensitive to the error are selected by taking into consideration the error correction capability.

In step 508, the mapping controller determines whether to apply the modulation scheme to each frame unit or block unit or to each symbol unit, in order to satisfy the target code rate. When the mapping controller determines in step 508 to apply the modulation scheme to each frame unit or block unit, the process proceeds to step 510. When the mapping controller determines in step 508 to apply the modulation scheme to each symbol, the process proceeds to step 512. In step 510, the mapping controller groups the interleaved signals into each frame or each block. In step 512, the mapping controller groups the interleaved signals into each symbol. In step 514, the mapper performs mapping according to the corresponding modulation scheme (i.e. the changed modulation order).

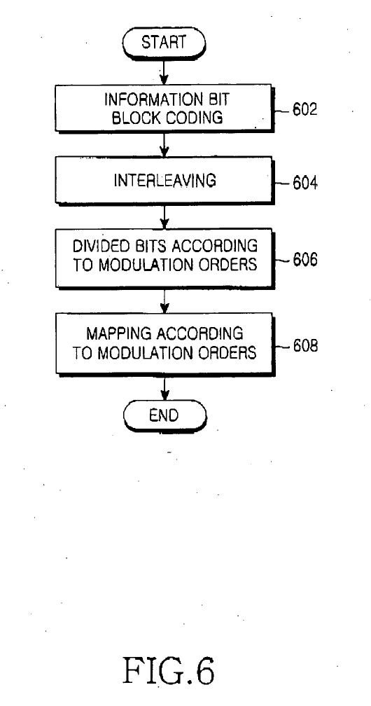

FIG. 6 is a flowchart of a process for data transmission in a communication system according to a preferred embodiment of the present invention.

First, in step 602, the information bit blocks are encoded. In step 604, the encoded bits are interleaved. The interleaving is a process for changing the order of the input bits to an irregular order, in order to prevent burst error generation while considering the influence of the channel fading and the reflexive decoding process.

In step 606, the mapping controller divides the interleaved bits according to the modulation orders. In step 608, the mapper groups the received bits into each symbol or each frame according to a corresponding modulation order and maps the symbol or frame according to a corresponding modulation scheme.

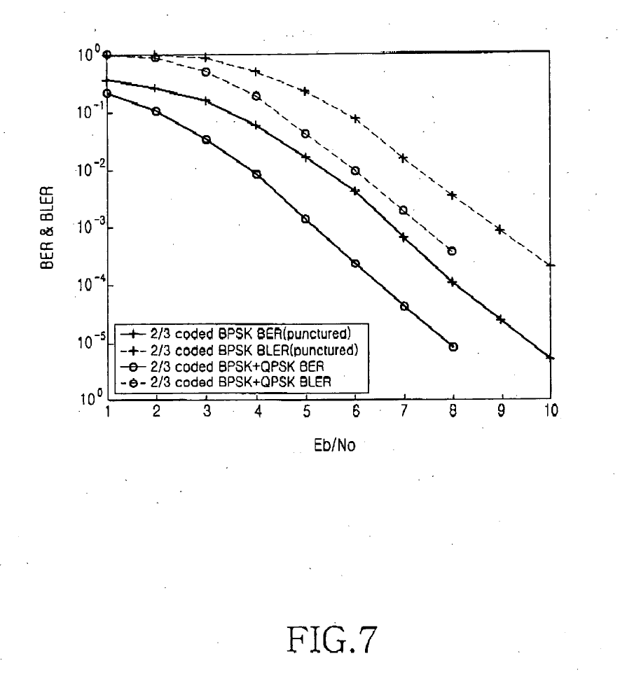

FIG. 7 is a graph for illustrating data rate performance according to a preferred embodiment of the present invention.

FIG. 7 compares a performance curve of the present invention which satisfies a target code rate of a system by changing the modulation order, for example, by using different modulation schemes such as BPSK and QPSK, with a performance curve of the conventional method which satisfies the target code rate by puncturing convolutional codes having a code rate of ½ and a state number of 64 for an input of 200 information bits. FIG. 7 is based on data rate of 0.66 bit/sec.

According to the method of the present invention as shown in FIG. 7, an output signal of the encoder is first modulated by a BPSK scheme, and even order bits are extracted and then modulated by a QPSK scheme. It is assumed that the channel is a Rayleigh fading channel which is independent for each symbol. Therefore, based on a bit error probability of 10⁻⁵, the method of the present invention can obtain a code gain of about 1.5 dB in comparison with the conventional method.

As described above, the present invention provides an apparatus and a method for efficiently transmitting data by constellation combination without performing puncturing in a communication system. Therefore, the present invention can prevent occurrence of time multiplexing loss. Further, the present invention can achieve a desired data rate by using combination of modulation orders without using the conventional puncturing. Therefore, the present invention can prevent reduction of the minimum hamming distance by performing the conventional puncturing, thereby reducing the bit error rate and improving the data rate. Also, the present invention can adaptively change a code rate by using a combination of various modulation schemes corresponding to the order of modulation. Therefore, the present invention can efficiently change the data rate in a communication system.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for data transmission in a communication system, the method comprising the steps of:
encoding and interleaving transmission data according to a predetermined encoding scheme, and dividing an interleaved signal into at least one signal interval corresponding to at least one modulation scheme; and
transmitting data obtained by modulating at least one divided signal interval according to a modulation scheme corresponding to the divided signal interval, the data satisfying a predetermined data rate setup in a system by applying a preset modulation scheme to each divided signal interval.

2. The method as claimed in claim 1, wherein the interleaved signal is divided into signal intervals having a uniform bit unit, each of the signal intervals corresponding to the preset modulation scheme.

3. The method as claimed in claim 1, wherein the interleaved signal is divided into signal intervals having non-uniform bit unit, each of the signal intervals corresponding to the preset modulation scheme.

4. The method as claimed in claim 1, wherein the preset modulation scheme is applied to each frame unit of each divided signal interval.

5. The method as claimed in claim 1, wherein the preset modulation scheme is applied to each symbol unit of each divided signal interval.

6. The method as claimed in claim 1, wherein the modulation schemes are identified by modulation orders having different values.

7. The method as claimed in claim 1, wherein the at least one modulation scheme includes a plurality of modulation schemes having different values and the interleaved signal is divided into the signal intervals in accordance with the plurality of modulation schemes.

8. The method as claimed in claim 1, wherein the data rate is obtained through signal mapping which applies different modulation orders to the divided signal intervals according to the modulation schemes.

9. An apparatus for data transmission in a communication system, the apparatus comprising:
a mapping controller for encoding and interleaving transmission data according to a predetermined encoding scheme, and dividing an interleaved signal into at least one signal interval corresponding to at least one modulation scheme; and
a mapper for transmitting data obtained by modulating at least one divided signal interval according to a modulation scheme corresponding to the divided signal interval, the data satisfying a predetermined data rate setup in a system by applying a preset modulation scheme to each divided signal interval.

10. The apparatus as claimed in claim 9, wherein the mapping controller divides the interleaved signal into signal intervals having a uniform bit unit, each of the signal intervals corresponding to the preset modulation scheme.

11. The apparatus as claimed in claim 9, wherein the mapping controller divides the interleaved signal into signal intervals having non-uniform bit unit, each of the signal intervals corresponding to the preset modulation scheme.

12. The apparatus as claimed in claim 9, wherein the mapping controller applies the preset modulation scheme to each frame unit of each divided signal interval.

13. The apparatus as claimed in claim 9, wherein the mapping controller applies the preset modulation scheme to each symbol unit of each divided signal interval.

14. The apparatus as claimed in claim 9, wherein the modulation schemes are identified by modulation orders having different values.

15. The apparatus as claimed in claim 9, wherein the at least one modulation scheme includes a plurality of modulation schemes having different values and the interleaved signal is divided into the signal intervals in accordance with the plurality of modulation schemes.

16. The apparatus as claimed in claim 9, wherein the mapper obtains the data rate through signal mapping which applies different modulation orders to the divided signal intervals according to the modulation schemes.

17. A method for data modulation and mapping in a communication system, the method comprising the steps of:
encoding and interleaving predetermined input data;
dividing an interleaved signal into signal intervals corresponding to a plurality of modulation schemes; and
mapping the signal intervals according to corresponding modulation schemes.

18. The method as claimed in claim 17, wherein the interleaved signal is divided into signal intervals having a uniform bit unit or a non-uniform bit unit, each of the signal intervals corresponding to a preset modulation scheme.

19. The method as claimed in claim 17, wherein the modulation scheme is applied to each frame or each symbol of the each divided signal interval.

20. The method as claimed in claim 17, wherein the modulation schemes include a plurality of modulation orders having different values and the interleaved signal is divided into the signal intervals in accordance with the plurality of modulation orders.
